(19) United States
(12) Patent Application Publication
(10) Pub. No.: US 2009/0159104 A1
(43) Pub. Date: Jun. 25, 2009

(54) METHOD AND APPARATUS FOR CHAMBER CLEANING BY IN-SITU PLASMA EXCITATION

(76) Inventors: Judy Huang, Los Gatos, CA (US); Michael S. Barnes, San Ramon, CA (US); Terry Bluck, Santa Clara, CA (US)

Correspondence Address: NIXON PEABODY, LLP, 401 9TH STREET, NW, SUITE 900, WASHINGTON, DC, 20004-2128, US

(21) Appl. No.: 11/960,442

(22) Filed: Dec. 19, 2007

(51) Int. Cl. B08B 6/00; B08B 13/00

(52) U.S. Cl. 134/104.1; 134/1.1

(57) ABSTRACT

A substrate processing chamber for processing substrates such as semiconductor wafers, flat panel substrate, solar panels, etc., includes mechanism for in-situ plasma clean. The chamber body has at least one plasma source opening provided on its sidewall. A movable substrate holder is situated within the chamber body, the substrate holder assumes a first position wherein the substrate is positioned below the plasma source opening for in-situ plasma cleaning of the chamber, and a second position wherein the substrate is positioned above the plasma source opening for substrate processing. A plasma energy source is coupled to the plasma source opening.

### BACKGROUND

1. Field of the Invention

The general field of the invention relates to a unique method and apparatus for plasma chamber cleaning by in-situ plasma excitation.

2. Related Arts

Various processing chambers, such as, e.g., vacuum chambers for semiconductor, flat panel, solar panel, etc., fabrication, require periodic cleaning. Such cleaning is conventionally done using plasma excitation. In the current art, there are two relevant known method for such cleaning, which are generally referred to as: remote plasma clean and in-situ plasma clean. Normally, the generation of plasma for cleaning purposes differes from the generation of plasma for the fabrication process. One driver for the difference is the need to avoid the chambers walls and chuck from being attacked by the plasma. Therefore, the design of the plasma cleaning operation requires the creation of “soft plasma.”

One well known method for generating “soft plasma” for cleaning purposes is the above-mentioned remote plasma clean system. In remote plasma clean system the plasma is generated remotely from the processing space that needs to be cleaned, and the generated radicals are allowed to float or migrate into the processing space for cleaning purposes. On the other hand, chambers employing in-situ chamber clean simply maintain the cleaning plasma under different conditions than the processing plasma. For example, source power may be reduced, and no bias power may be applied, so as to avoid accelerating radicals in the plasma.

One class of processing chambers requiring the above periodical cleaning is chemical vapor deposition (CVD) chambers. While some forms of plasma assisted or plasma enhanced CVD chambers are utilized, conventional CVD chambers do not utilize plasma for the CVD process. Consequently, such CVD chambers do not have plasma generation capability, other than for cleaning purposes. Therefore, conventional CVD chambers utilize the remote plasma clean method, for example, remote microwave plasma clean.

A need still exists in the art for improved plasma chamber clean. Remote plasma clean suffers from low efficiency due to high recombination rate of reactive species during the transfer from the remote plasma chamber to the processing chamber. On the other hand, state of the art in-situ plasma cleans are generally limited to chambers where plasma is used for the processing, i.e., excludes chambers such as CVD chambers. Moreover, the plasma apparatus conventionally used for in-situ clean is the same apparatus used for the processing of the substrate. Consequently, in general such apparatus is optimized for generating processing plasma, while leaving the cleaning plasma just as a side option.

### SUMMARY

The following summary of the invention is provided in order to provide a basic understanding of some aspects and features of the invention. This summary is not an extensive overview of the invention, and as such it is not intended to particularly identify key or critical elements of the invention, or to delineate the scope of the invention. Its sole purpose is to present some concepts of the invention in a simplified form as a prelude to the more detailed description that is presented below.

According to aspects of the invention, there is provided a novel in-situ plasma cleaning method and apparatus. Various embodiments of the invention utilize the chamber body as part of the resonance cavity for generating the plasma in situ. Consequently, improved control of the plasma characteristics is enabled, while avoiding reactive species recombination.

According to aspects of the invention, a substrate processing chamber is provided, comprising: a chamber body having at least one plasma source opening provided on a sidewall thereof, a movable substrate holder situated within the chamber body, the substrate holder assuming a first position wherein the substrate is positioned below the plasma source opening, and a second position wherein the substrate is positioned above the plasma source opening; a plasma source coupled to the plasma source opening; a vacuum pump coupled to the chamber body to pump fluid therefrom; and a gas source couple to the chamber body to inject gas thereto. The plasma source opening may comprise a dielectric window and wherein the plasma source comprises a microwave source. The plasma source may comprise an RF energy source applying RF power to a coil wound about a tubular pipe, the tubular pipe being connected in fluid communication to the plasma source opening. The tubular pipe may comprise a dielectric pipe. The tubular pipe may comprise a conductor pipe having a dielectric break. The tubular pipe may be connected to the chamber body at two points opposing each other at 180 degrees.

According to aspects of the invention, a processing chamber having in-situ plasma clean capability is provided, comprising: a chamber body having a sidewall; a showerhead provided over the chamber body; a plasma energy source coupled to the sidewall of the chamber body; a movable substrate holder having an upper position for placing the substrate at a small gap below the showerhead while being above the plasma energy source, and a lower position below the plasma energy source. The plasma energy source may be a dielectric window. The plasma energy source may be an RF energy source. The plasma energy source may be a tubular pipe coupled to the sidewall. The tubular pipe may be conductive and further comprises a dielectric break.

According to aspects of the invention, a method for operating a substrate processing chamber having plasma energy source on a sidewall thereof for in-situ chamber cleaning is provided, comprising: loading a substrate onto a substrate holder situated in the chamber; raising the substrate holder to a level above the plasma energy source; processing the substrate; lowering the substrate holder to a level below the plasma energy source; unloading the substrate; activating the plasma energy source to ignite and maintain plasma within the chamber to perform in-situ chamber clean.

According to aspects of the invention, a method for operation the chamber, in a substrate processing chamber having variable processing cavity, is provided, comprising: placing the chamber in a first mode of operation by setting the variable cavity to a first volume; processing the substrate; placing the chamber in a second mode of operation by enlarging the variable cavity to assume a second volume larger than the first volume; striking and maintaining plasma within the variable cavity at its second volume to thereby perform in-situ cleaning of the variable cavity.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIGS. 1A and 1B depict an example of a processing chamber according to an embodiment of the invention, wherein in FIG. 1A the chamber is positioned for plasma cleaning, while in FIG. 1B the chamber is positioned for processing.

FIGS. 2A and 2B illustrate another example of a processing chamber according to an embodiment of the invention, wherein in FIG. 2A the chamber is positioned for plasma cleaning, while in FIG. 2B the chamber is positioned for processing.

FIG. 3 illustrates a process according to an embodiment of the invention.

FIGS. 4A and 4B illustrate another example of a processing chamber according to an embodiment of the invention, wherein in FIG. 4A the chamber is positioned for plasma cleaning, while in FIG. 4B the chamber is positioned for processing.

FIGS. 5A and 5B illustrate another example of a processing chamber according to an embodiment of the invention, wherein in FIG. 5A the chamber is positioned for plasma cleaning, while in FIG. 5B the chamber is positioned for processing.

### DETAILED DESCRIPTION

Various embodiments of the invention are generally directed to plasma chamber clean, wherein the plasma is ignited and maintain in-situ, i.e., in the same cavity where processing takes place. The various embodiments described herein may be used, for example, in connection with various processing chambers used in fabricating semiconductor wafers, flat panel display, solar panels, etc. Among such processing chambers, the embodiments are suitable for use with, e.g., etch, CVD, PECVD, PVD, etc. Of course, the various embodiments and techniques described herein may have other applications not specifically mentioned herein.

In its conceptual implementation, the inventive chamber has two modes of operation with variable cavity. In the first mode of operation the cavity is set to a first volume for substrate processing, and in the second mode of operation the cavity is set to a second volume for in-situ cleaning. In the first mode of operation the substrate is processed and plasma may or may not be used. In the second mode of operation the cavity is enlarged and plasma is maintained for cleaning the chamber.

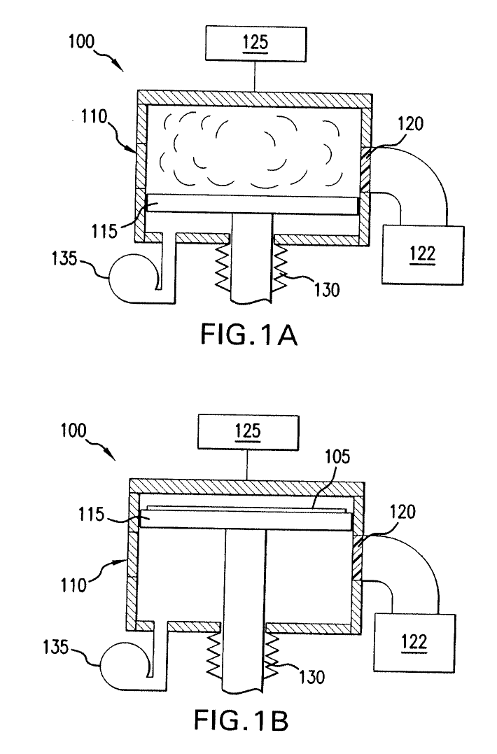

FIGS. 1A and 1B depict an example of a processing chamber according to an embodiment of the invention, wherein in FIG. 1A the chamber is positioned for plasma cleaning, while in FIG. 1B the chamber is positioned for processing. The processing chamber 100 may be, e.g., a CVD chamber for producing high purity thin firms on a substrate 105; however, as noted above, other chambers may employ the in-situ cleaning according to this embodiment. The substrate 105 is loaded into the chamber via load lock 110, and is placed on a substrate holder, such as chuck 115. Once the substrate 105 is placed on the chuck 115, the chuck is raised into processing position, shown in FIG. 1B. Pump 135 is used to evacuate the chamber 100, while bellows 130 or other means may be used to enable movement of the chuck 115 without breaking the vacuum environment. The processing position places the substrate above the load lock 115 and above the dielectric window 120. Then, precursor gas from gas source 125 is introduced into the chamber to deposit the required layer on the substrate 105.

As is well known, during CVD processing, thin film is deposited on the substrate, and incidentally also deposited on the chamber walls. The deposition on the chamber wall needs to be removed, since otherwise it may flake off and contaminate subsequent wafers. Therefore, after the chuck 115 has been lowered and the wafer 105 removed from the chamber, the load lock 110 can be sealed and an in-situ plasma cleaning process may be carried on. According to this embodiment, inert and reactive gas, such as, e.g., Ar, He, NF3 (or any Flourine contained gases) etc., is introduced into the chamber under low pressure condition, e.g., lower than 10 Torr. Then, microwave energy from microwave source 122 is introduced into the chamber via dielectric window 120, to thereby strike and maintain plasma within the chamber. Depending on the requirements and the design, the microwave energy may assume various values, for example frequency of 2.45 GHz at power range of 100 W-10 kW.

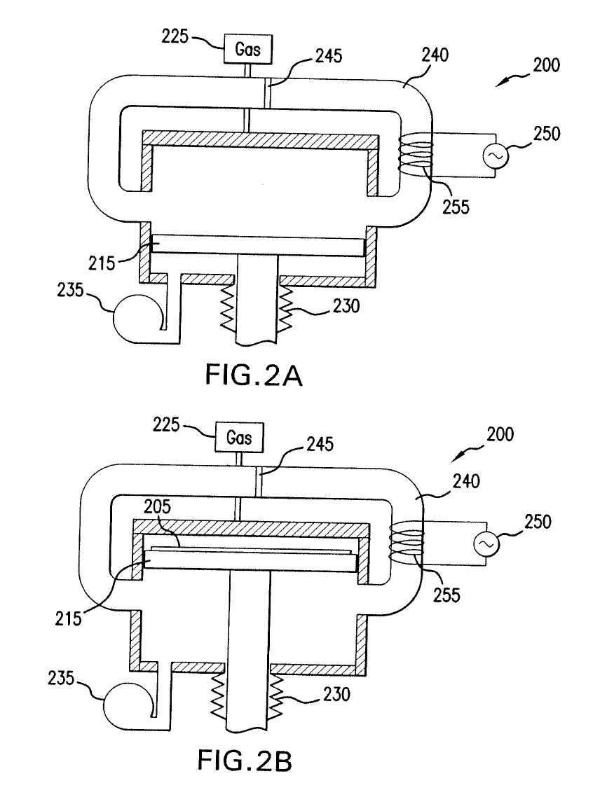

FIGS. 2A and 2B illustrate another example of a processing chamber according to an embodiment of the invention, wherein in FIG. 2A the chamber is positioned for plasma cleaning, while in FIG. 2B the chamber is positioned for processing. Elements in FIGS. 2A and 2B that are similar to those in FIGS. 1A and 1B are indicated by the same numerical references, except that they are in the 2xx series.

In FIG. 2B, the chuck is raised into the processing position, and processing proceeds just like in the embodiment of FIG. 1B. On the other hand, in FIG. 2A the chuck is lowered for plasma cleaning operation. As with the embodiment of FIGS. 1A and 1B, in-situ plasma clean is performed in FIG. 2A. However, in this embodiment rather than using a microwave energy, an RF energy is inductively coupled into a conduit 240 that is connected to the chamber. As shown in FIG. 2A, a conduit 240 is connected to the chamber 200, forming a closed-circuit fluid communication with the variable cavity 202. In this example, the conduit 240 is connected to the chamber 200 at two points opposing each other at 180 degrees. The conduit 240 may be made of a dielectric material, or may be made of a conductive material, in which case it includes a dielectric break 245. RF energy from RF source 250 is inductively coupled into the conduit 240 via coil 255. Consequently, plasma is ignited in the closed-circuit fluid path that comprises the chamber's variable cavity 202 and conduit 240.

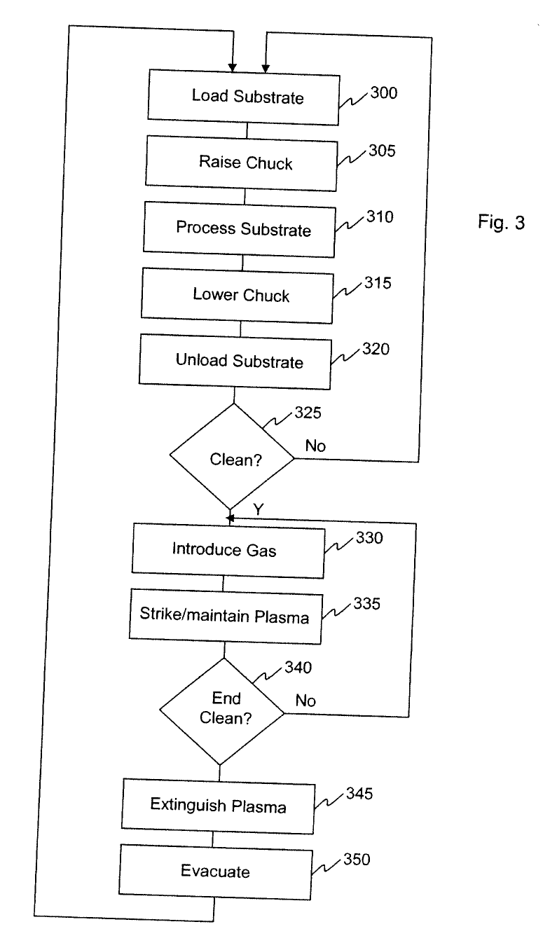

FIG. 3 illustrates a process according to an embodiment of the invention. The process of FIG. 3 may be implemented in any processing chamber constructed according to embodiment of the invention. In step 300 a substrate is loaded onto the substrate holder and the load lock is sealed. The chamber may be maintained in vacuum or low pressure condition. In step 305 the chuck is raised to its processing position, and in step 310 the substrate is processed. As noted above, processing the substrate may include etching, deposition, annealing, etc. Once processing is completed, at step 315 the chuck is lowered to its substrate unloading position and the substrate is unloaded at step 320.

At step 325 it is determined whether cleaning cycle is required. That is, under some conditions cleaning cycle may be performed after every processing cycle. However, under other situation cleaning may be performed after every n processing cycles, after T time has passed, by observing process results, etc. If no cleaning is required, the process proceeds to step 300. Otherwise, a cleaning cycle is started at step 330 by introducing cleaning gas, such a mixture of inert gas and active gas.

It should be noted at this point that the chuck may also be moved to a different position. That is, the chuck cleaning position may be different from the chuck substrate unloading position. Notably, for substrate unloading the chuck needs to clear the load lock. On the other hand, for cleaning cycle the chuck must clear the plasma energy source, such as the dielectric window, the opening of the conduit 240, etc. For simplicity, in the example of FIG. 3 it is assumed that the substrate unloading and chamber cleaning positions are the same.

At step 335 the plasma source is energized to strike and maintain plasma in the chamber. At step 340 it is checked whether the end of the cleaning cycle is reached. This may be done by, e.g., using a timer or by analyzing the species that are being evacuated from the chamber. For example, when source gas, e.g., NF3, is used to generate fluorine radicals in order to clean silicon deposits from the chamber, the exhaust may be monitored for the presence of SiF4. As long as SiF4 is present in the evacuating gas, cleaning may continue by continuing to introduce gas and maintaining the plasma (steps 330 and 335). Absence of SiF4 signifies end of cleaning, and the process proceeds to step 345, where the plasma is extinguished. Optimally, the chamber may be pumped an additional period of time before reverting to step 300 to load the next substrate.

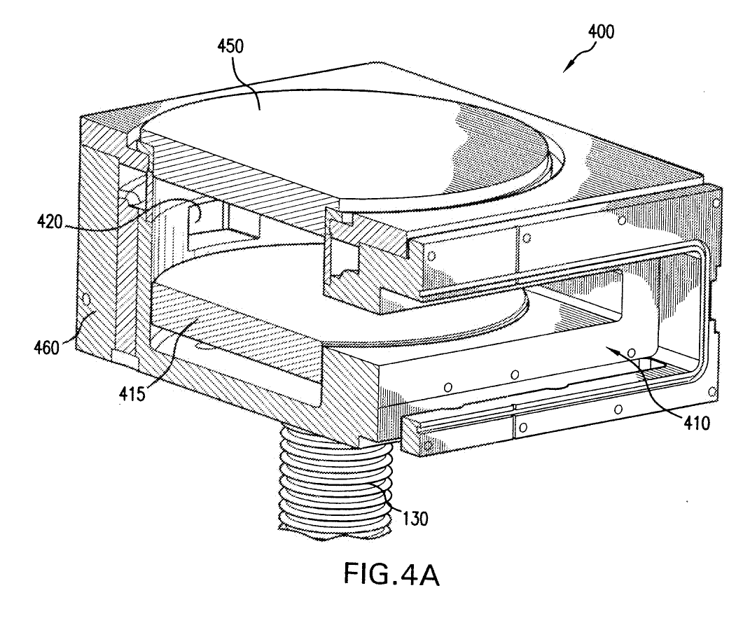

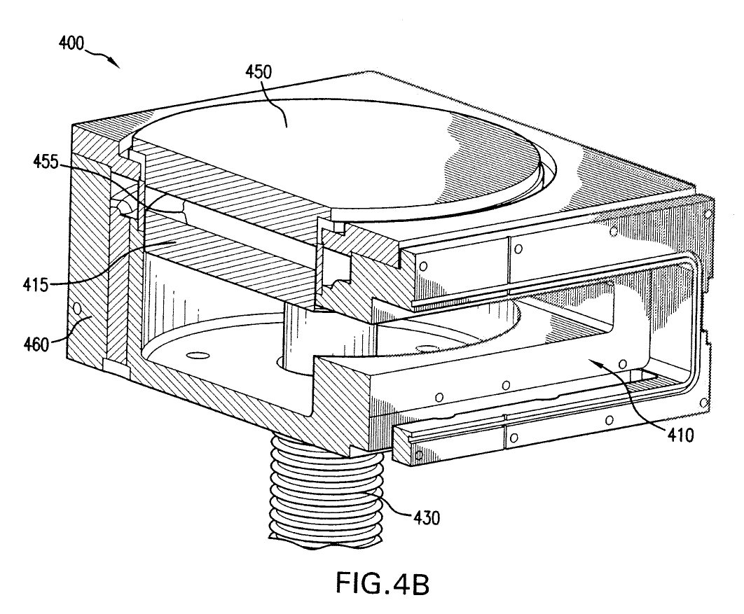

FIGS. 4A and 4B illustrate another example of a processing chamber according to an embodiment of the invention, wherein in FIG. 4A the chamber is positioned for plasma cleaning, while in FIG. 4B the chamber is positioned for processing. Elements in FIGS. 4A and 4B that are similar to those in FIGS. 1A and 1B are indicated by the same numerical references, except that they are in the 4xx series. FIGS. 4A and 4B are partial cross-section of 3-d model of the chamber. In this particular example, the chamber is normally used for CVD; however, other chambers may be used as well.

As shown in FIG. 4A, the CVD chamber 400 of this embodiment has a chamber body 460 having internal cavity wherein a substrate can be processed. The substrate is loaded and unloaded from load lock opening 410, as is placed on substrate holder 415. In FIG. 4A the substrate holder is shown in its lowered position, which allows for substrate loading and unloading, and also allows for chamber plasma cleaning operation. A showerhead 450 provides process gas and plasma cleaning gas. In this example, a plasma source opening 420 is provided on the sidewall of the chamber body 460. Here, the plasma source opening enables coupling of microwave energy into the cavity for striking and maintaining plasma for chamber cleaning operation.

In FIG. 4B the substrate holder 415 assumes the upper position, which is utilized for substrate processing. Notably, when the substrate holder 415 assumes the processing position, the gap 455 is narrow, and the substrate clears, i.e., is above, the level of the plasma source opening 420 (not visible in FIG. 4B, as it is being obscured by the substrate holder 415).

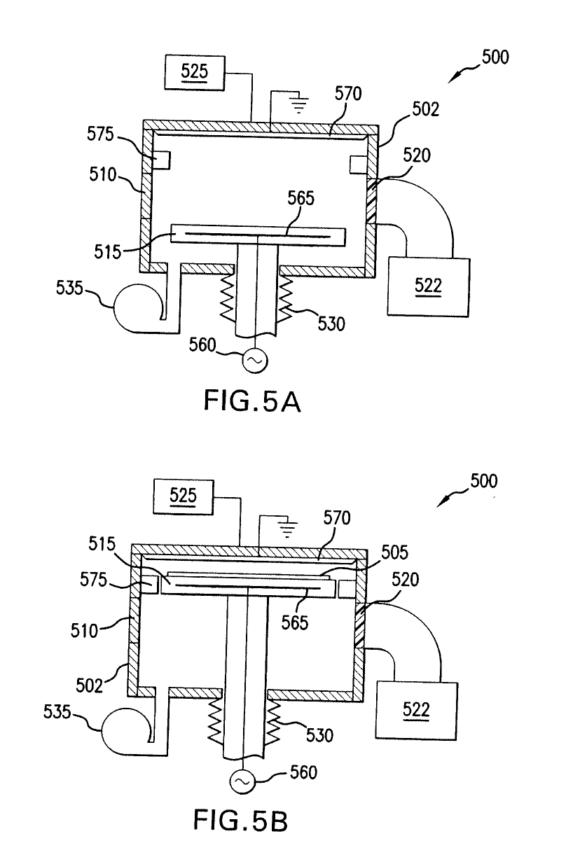

FIGS. 5A and 5B illustrate another example of a processing chamber according to an embodiment of the invention, wherein in FIG. 5A the chamber is positioned for plasma cleaning, while in FIG. 5B the chamber is positioned for processing. Elements in FIGS. 5A and 5B that are similar to those in FIGS. 1A and 1B are indicated by the same numerical references, except that they are in the 5xx series.

The chamber of FIGS. 5A and 5B includes two plasma sources, a capacitive RF coupling for plasma processing of the substrate and a microwave source for in-situ cleaning. For plasma processing of the substrate 505, RF energy from RF source 560 is coupled between a conductive electrode 565 embedded in the substrate support 515 and a conductive electrode 570 on the ceiling of the chamber. Here, the conductive electrode 570 is shown grounded while the conductive electrode 565 is shown connected to the hot side of the RF source 560, but it should be appreciated that the reverse is just as equally applicable. Also, while only one RF source is shown, it is known in the art to couple more than one RF sources, so as to couple more than one RF frequencies into the chamber. As is also known in the art, conductive electrode 570 may form part of a showerhead to inject gas from gas source 525 into the chamber.

When the chamber of FIGS. 5A and 5B is used for plasma processing, it may be used, e.g., to perform etch on the substrate. As is known, residency time of plasma species is an important factor in the quality of the etch process, which leads to enhanced requirement for pumping, i.e., chamber conductance. Therefore, in the chamber of FIGS. 5A and 5B the substrate holder 515 is made of a diameter smaller than the diameter of the chamber wall 502. Consequently, this configuration leaves much space between the edge of the substrate holder 515 and the chamber wall 502 for improved conductance. On the other hand, if the space is left open, plasma maintained for processing may travel below the substrate holder 505. To prevent that, a baffle 575 is situated at the level for substrate processing, as shown in FIG. 5B. When the substrate holder is raised for processing, i.e., situation shown in FIG. 5B, the substrate holder 515 is at the same level as the baffle 575, thereby presenting a closed space to the plasma. However, the baffle 575 includes holes of small size designed to enable gas pumping, but to appear as a barrier to the plasma.

On the other hand, when the substrate holder is positioned for in-situ cleaning, i.e., position shown in FIG. 5A, the RF source 560 may be turned off, and microwave source 522 may be energized to ignite plasma for in situ cleaning of the chamber.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, HFSS, CST, EEKO, etc.

The present invention has been described in relation to particular examples, which are intended in all respects to be illustrative rather than restrictive. Those skilled in the art will appreciate that many different combinations of hardware, software, and firmware will be suitable for practicing the present invention. Moreover, other implementations of the invention will be apparent to those skilled in the art from consideration of the specification and practice of the invention disclosed herein. It is intended that the specification and examples be considered as exemplary only, with a true scope and spirit of the invention being indicated by the following claims.

1. A substrate processing chamber comprising:
a chamber body having at least one plasma source opening provided on a sidewall thereof;
a movable substrate holder situated within the chamber body, the substrate holder assuming a first position wherein the substrate is positioned below the plasma source opening, and a second position wherein the substrate is positioned above the plasma source opening;
a plasma source coupled to the plasma source opening;
a vacuum pump coupled to the chamber body to pump fluid therefrom;
a gas source couple to the chamber body to inject gas thereto.

2. The processing chamber of claim 1, wherein the plasma source opening comprises a dielectric window and wherein the plasma source comprises a microwave source.

3. The processing chamber of claim 1, wherein the plasma source comprises an RF energy source applying RF power to a coil wound about a tubular pipe, the tubular pipe being connected in fluid communication to the plasma source opening.

4. The processing chamber of claim 3, wherein the tubular pipe comprises a dielectric pipe.

5. The processing chamber of claim 3, wherein the tubular pipe comprises a conductor pipe having a dielectric break.

6. The processing chamber of claim 1, wherein the tubular pipe is connected to the chamber body at two points opposing each other at 180 degrees.

7. A processing chamber having in-situ plasma clean capability, comprising:
a chamber body having a sidewall;
a showerhead provided over the chamber body;
a plasma energy source coupled to the sidewall of the chamber body;
a movable substrate holder having an upper position for placing the substrate at a small gap below the showerhead while being above the plasma energy source, and a lower position below the plasma energy source.

8. The processing chamber of claim 7, wherein the plasma energy source is a dielectric window.

9. The processing chamber of claim 7, wherein the plasma energy source is an RF energy source.

10. The processing chamber of claim 7, wherein the plasma energy source is a tubular pipe coupled to the sidewall.

11. The processing chamber of claim 10, wherein the tubular pipe is conductive and further comprises a dielectric break.

12. A method for operating a substrate processing chamber having plasma energy source on a sidewall thereof for in-situ chamber cleaning, comprising:
loading a substrate onto a substrate holder situated in the chamber;
raising the substrate holder to a level above the plasma energy source;
processing the substrate;
lowering the substrate holder to a level below the plasma energy source;
unloading the substrate;
activating the plasma energy source to ignite and maintain plasma within the chamber to perform in-situ chamber clean.

13. In a substrate processing chamber having variable processing cavity, a method for operation the chamber, comprising:
placing the chamber in a first mode of operation by setting the variable cavity to a first volume;
processing the substrate;
placing the chamber in a second mode of operation by enlarging the variable cavity to assume a second volume larger than the first volume;
striking and maintaining plasma within the variable cavity at its second volume to thereby perform in-situ cleaning of the variable cavity.
